(19) United States
(12) Patent Application Publication
(10) Pub. No.: US 2026/0075597 A1
(43) Pub. Date: Mar. 12, 2026

(54) METHOD AND APPARATUS FOR WIRELESS COMMUNICATIONS

(71) Applicant: QUECTEL WIRELESS SOLUTIONS CO., LTD., Shanghai (CN)

(72) Inventors: Ling LYU, Shanghai (CN); Zheng ZHAO, Shanghai (CN)

(21) Appl. No.: 19/390,455

(22) Filed: Nov. 14, 2025

Related U.S. Application Data
(63) Continuation of application No. PCT/CN2024/107905, filed on Jul. 26, 2024.

(51) Int. Cl. H04W 72/0453; H04W 52/02; H04W 72/1273

(52) U.S. Cl. CPC H04W 72/0453; H04W 52/0229; H04W 72/1273

(57) ABSTRACT

A method and an apparatus for wireless communications are provided. One example method includes: determining, by a terminal device, configuration information of a first resource; and transmitting, by the terminal device, a first request on the first resource. The configuration information of the first resource is carried in a master information block, and the first request is used to request an on-demand first system information block (SIB1).

### CROSS-REFERENCE TO RELATED APPLICATIONS

This application is a continuation of International Application No. PCT/CN2024/107905, filed on Jul. 26, 2024, the disclosure of which is hereby incorporated by reference in its entirety.

### TECHNICAL FIELD

The present application relates to the technical field of communications, and more specifically, to a method and an apparatus for wireless communications.

### BACKGROUND

To serve a terminal device, a network device typically transmits system information blocks (SIB) periodically. However, in scenarios where there is no demand from the terminal device or no terminal device is camped in the cell, the periodic transmission of SIB by the network device results in significant energy waste. Therefore, how to perform on-demand transmission of SIB and related resource configuration has become a pressing technical problem to be solved in order to achieve energy saving.

### SUMMARY

A method and an apparatus for wireless communications are provided according to the present application. Various aspects involved in the embodiments of the present application are described below.

In a first aspect, a method for wireless communications is provided. The method includes: determining, by a terminal device, configuration information of a first resource; and transmitting, by the terminal device, a first request on the first resource. The configuration information of the first resource is carried in a master information block, and the first request is used to request a first SIB.

In a second aspect, a method for wireless communications is provided. The method includes: transmitting, by a network device, configuration information of a first resource; and receiving, by the network device, a first request transmitted by a terminal device on the first resource. The configuration information of the first resource is carried in a master information block, and the first request is used to request a first SIB.

In a third aspect, an apparatus for wireless communications is provided. The apparatus is a terminal device, and includes: a determining unit, for determining configuration information of a first resource; and a transmitting unit, for transmitting a first request on the first resource. The configuration information of the first resource is carried in a master information block, and the first request is used to request a first SIB.

In a fourth aspect, an apparatus for wireless communications is provided. The apparatus is a network device, and includes: a transmitting unit, for transmitting configuration information of a first resource; and a receiving unit, for receiving a first request transmitted by a terminal device on the first resource. The configuration information of the first resource is carried in a master information block, and the first request is used to request a first SIB.

In a fifth aspect, a communications apparatus is provided. The communications apparatus includes: a memory for storing a program; and a processor for invoking the program from the memory to perform the method as described in the first or second aspect.

In a sixth aspect, an apparatus is provided. The apparatus includes: a processor for invoking a program from a memory to perform the method as described in the first or second aspect.

In a seventh aspect, a chip is provided. The chip includes: a processor for invoking a program from a memory, to cause a device incorporating the chip performs the method as described in the first or second aspect.

In an eighth aspect, a computer-readable storage medium is provided, on which a program is stored, the program causing a computer to perform the method as described in the first or second aspect.

In a ninth aspect, a computer program product is provided. The computer program product includes: a program, the program causing a computer to perform the method as described in the first or second aspect.

In a tenth aspect, a computer program is provided, the computer program causing a computer to perform the method as described in the first or second aspect.

In the embodiments of the present application, a terminal device can determine configuration information of a first resource in a master information block, and then transmit a first request on the first resource to request the first SIB. Thus, the terminal device can timely determine the configured time-frequency resources through the master information block, and transmit a request for triggering on-demand transmission of SIB1. The network device transmits the on-demand SIB1 by request, thereby saving network energy.

### BRIEF DESCRIPTION OF THE DRAWINGS

FIG. 1 is a diagram of a wireless communications system applied in the embodiments of the present application.

FIG. 2 is a schematic diagram of on-demand transmission of SIB1 based on an uplink wake-up signal.

FIG. 3 is a flowchart illustrating a method for wireless communications according to embodiments of the present application.

FIG. 4 is a schematic diagram illustrating a possible correspondence between synchronization signal block indexes and SIB1 time-frequency resources.

FIG. 5 is a schematic diagram illustrating another possible correspondence between synchronization signal block indexes and SIB1 time-frequency resources.

FIG. 6 is a schematic diagram illustrating another possible correspondence between synchronization signal block indexes and SIB1 time-frequency resources.

FIG. 7 is a schematic diagram illustrating another possible correspondence between synchronization signal block indexes and SIB1 time-frequency resources.

FIG. 8 is a structural diagram of an apparatus for wireless communications according to embodiments of the present application.

FIG. 9 is a structural diagram of an apparatus for wireless communications according to other embodiments of the present application.

FIG. 10 is a structural diagram of a communications apparatus according to the embodiments of the present application.

### DETAILED DESCRIPTION OF THE EMBODIMENTS

The technical solutions in the embodiments of the present application will be described below in conjunction with the accompanying drawings of the embodiments of the present application. Obviously, the described embodiments are only part of the embodiments of the present application, and not all embodiments. All other embodiments obtained by those of ordinary skill in the art based on the embodiments in the present application without inventive efforts shall fall within the protection scope of the present application.

The embodiments of the present application can be applied to various communications systems. For example, the embodiments of the present application can be applied to global system of mobile communication (GSM) systems, code division multiple access (CDMA) systems, wideband code division multiple access (WCDMA) systems, general packet radio service (GPRS), long term evolution (LTE) systems, advanced long term evolution (LTE-A) systems, new radio (NR) systems, evolved NR systems, LTE-based access to unlicensed spectrum (LTE-U) systems, NR-based access to unlicensed spectrum (NR-U) systems, NTN systems, universal mobile telecommunications systems (UMTS), wireless local area networks (WLAN), wireless fidelity (WiFi), and 5th-generation (5G) communications systems. The embodiments of the present application can also be applied to other communications systems, such as future communications systems. Such future communications systems can include, for example, 6th-generation (6G) mobile communications systems, satellite communications systems, or the like.

Traditional communications systems support a limited number of connections and are relatively easy to implement. However, with the development of communication technologies, communications systems can now support not only traditional cellular communications but also one or more other types of communications. For example, a communications system can support one or more of the following communications: device-to-device (D2D) communication, machine-to-machine (M2M) communication, machine type communication (MTC), enhanced machine type communication (eMTC), vehicle-to-vehicle (V2V) communication, and vehicle-to-everything (V2X) communication, etc. The embodiments of the present application can also be applied to communications systems that support the aforementioned communications method.

The communications system in the embodiments of this application can be applied to carrier aggregation (CA) scenarios, dual connectivity (DC) scenarios, and standalone (SA) networking scenarios.

The communications system in the embodiments of this application can be applied to unlicensed spectrum. This unlicensed spectrum can also be considered shared spectrum. Alternatively, the communications system in the embodiments of this application can also be applied to licensed spectrum. This licensed spectrum can also be considered dedicated spectrum.

The embodiments of this application can be applied to an NTN system. For example, the NTN system can include a 4G-based NTN system, an NR-based NTN system, an Internet of Things (IoT)-based NTN system, and a narrow band Internet of Things (NB-IoT)-based NTN system.

The communications system may include one or more terminal devices. The terminal device mentioned in the embodiments of this application may also be referred to as user equipment (UE), an access terminal, a user unit, a user station, a mobile station (MS), a mobile terminal (MT), a remote station, a remote terminal, a mobile device, a user terminal, a terminal, a wireless communications device, a user agent, or a user apparatus.

In some embodiments, the terminal device may be a STATION (ST) in the WLAN. In some embodiments, the terminal device may be a cellular phone, a cordless phone, a session initiation protocol (SIP) phone, a wireless local loop (WLL) station, a personal digital assistant (PDA) device, a handheld device with a wireless communications function, a computing device, or another processing device connected to a wireless modem, an in-vehicle device, a wearable device, a terminal device in a next-generation communications system (e.g., an NR system), or a terminal device in a future evolved public land mobile network (PLMN) network.

In some embodiments, the terminal device may be a device that provides voice and/or data connectivity to a user. For example, the terminal device may be a handheld device, an in-vehicle device, or the like that has a wireless connection function. In some specific examples, the terminal device may be a mobile phone, a Pad, a notebook computer, a laptop computer, a mobile internet device (MID), a wearable device, a virtual reality (VR) device, an augmented reality (AR) device, a wireless terminal in industrial control, a wireless terminal in self-driving, a wireless terminal in a remote medical surgery, a wireless terminal in a smart grid, a wireless terminal in a transportation safety, a wireless terminal in a smart city, a wireless terminal in a smart home, or the like.

In some embodiments, the terminal device may be deployed on land. For example, the terminal device may be deployed indoors or outdoors. In some embodiments, the terminal device may be deployed on water, such as being deployed on a ship. In some embodiments, the terminal device may be deployed in the air, such as being deployed on an aircraft, balloon, or satellite.

In addition to the terminal device, the communications system may further include one or more network devices. The network device in the embodiments of this application may be a device used to communicate with a terminal device, and the network device may also be referred to as an access network device or a radio access network device. The network device may be, for example, a base station. The network device in the embodiments of this application may be a radio access network (RAN) node (or device) that accesses a radio network by using a terminal device. The base station may broadly cover various names in the following, or may be replaced with the following names: a node B (NodeB), an evolved NodeB (eNB), a next-generation base station (next generation NodeB, gNB), a relay station, a transmitting and receiving point (TRP), a transmit point (TP), a master station (MeNB), a secondary station (SeNB), a multimode radio (MSR) node, a home base station, a network controller, an access node, a wireless node, an access point (AP), a transmit node, a transceiver node, a baseband unit (BBU), a remote radio unit (RRU), an active antenna unit (AAU), a remote radio head (RRH), a central unit (CU), a distributed unit (DU), a positioning node or the like. The base station may be a macro base station, a micro base station, a relay node, a donor node, or the like, or a combination thereof. The base station may further refer to a communications module, a modem, or a chip that is configured to be disposed in the foregoing device or apparatus. The base station may also be a mobile switching center, as well as a device performing the base station function in D2D, V2X, and M2M communications, a network-side device in a 6G network, or a device performing the base station function in future communications systems. The base station may support networks with the same or different access technologies. The embodiments of the present application do not limit the specific technologies or specific device forms used by the network device.

The base station may be stationary or mobile. For example, a helicopter or drone may be configured to act as a mobile base station, and one or more cells may be moved according to the location of the mobile base station. In other examples, a helicopter or drone may be configured as a device for communicating with another base station.

In some deployments, the network device in this embodiment of this application may refer to a CU or DU, or the network device includes a CU and a DU. The gNB may further include an AAU.

By way of example rather than limitation, in the embodiments of the present application the network device is mobile, for example, the network device is a mobile device. In some embodiments of the present application, the network device may be a satellite or a balloon station. In some other embodiments, the network device may also be a base station deployed on land, over water, or at other locations.

In the embodiments of the present application, the network device may serve a cell. A terminal device may communicate with the network device via transmission resources (e.g., frequency domain resources, or spectrum resources) used by the cell. The cell may correspond to the network device (e.g., a base station). The cell may belong to a macro base station or to a base station corresponding to a small cell. The small cell may include, for example, a metro cell, a micro cell, a pico cell, or a femto cell. These small cells are characterized by limited coverage and low transmission power, and are suitable for providing high-rate data transmission services.

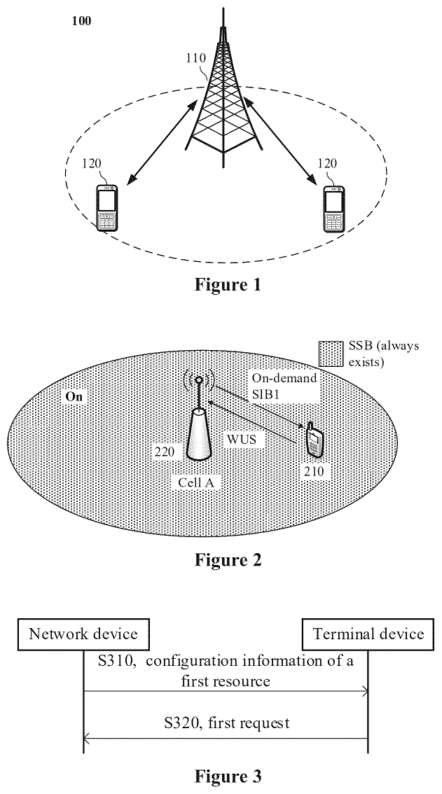

For example, FIG. 1 is a schematic architecture diagram of a communications system according to embodiments of this application. As shown in FIG. 1, the communications system 100 may include a network device 110, which may be a device that communicates with the terminal device 120 (or referred to as a communications terminal or a terminal). The network device 110 may provide communication coverage for a specific geographical area, and may communicate with a terminal device located in the coverage area.

FIG. 1 exemplarily illustrates one network device and two terminal devices. In some embodiments of the present application, the communications system 100 may include multiple network devices, and a coverage of each network device may include other numbers of terminal devices. The embodiments of the present application are not limited in this regard.

In embodiments of the present application, the communications system shown in FIG. 1 may further include other network entities such as a mobility management entity (MME) and an access and mobility management function (AMF). The embodiments of the present application are not limited in this regard.

It should be understood that, in the embodiments of the present application, a device in the network/system that has communication functionality may be referred to as a communications device. Taking the communications system 100 illustrated in FIG. 1 as an example, the communications device may include the network device 110 and the terminal device 120, both of which have communication capabilities. The network device 110 and the terminal device 120 may be the specific devices described above and will not be repeated here. The communications device may also include other devices in the communications system 100, such as a network controller, the mobility management entity, and other network entities. The embodiments of the present application are not limited in this regard.

For ease of understanding, some related technical concepts involved in the embodiments of the present application are introduced first. The following related technologies may be optionally combined with the technical solutions of the embodiments of the present application in any manner, and all such combinations fall within the scope of protection of the embodiments of the present application. The embodiments of the present application include at least part of the following contents.

With the development of mobile communication technologies, the next-generation wireless evolution systems (e.g., 5G system) employ various technologies to improve data transmission rates in order to meet the high data volume requirements of applications such as high-definition video and virtual reality. These technologies include, for example, massive multiple-input multiple-output (MIMO) technology, non-orthogonal multiple access technology, full-duplex communication at the same frequency and time, novel modulation techniques, novel coding techniques, and high-order modulations. These technologies enable support for peak data rates reaching Gbit/s levels.

For example, a latency for an air interface is required to be around 1 ms to support real-time applications such as autonomous driving and remote medical services.

For example, ultra-large network capacity may provide connectivity for tens of billions of devices, thereby meeting the communication requirements of the Internet of Things.

For example, the spectral efficiency of the NR system may be more than ten times that of the LTE system. Based on continuous wide-area coverage and high mobility, a data rate perceived by users can reach 100 Mbit/s. This indicates a substantial increase in both traffic density and connection density.

In addition, improvements in system coordination and intelligence further enhance the flexibility of the network. System coordination may be reflected in coordinated networking involving multiple users, multiple points, multiple antennas, and multiple access links. Based on coordination and intelligence, networks can be flexibly and automatically adjusted.

However, in communications systems, the power consumption of network devices (e.g., base station devices) is typically high. To reduce the power consumption of base station devices, system messages need to be optimized. For ease of understanding, the following description takes the system messages of an NR system as an example.

System messages in an NR system may be classified into a master information block (MIB) message and several SIB messages. The MIB message is typically transmitted over a broadcast channel (BCH). The transmission period of the MIB is 80 ms. The MIB may be repeatedly transmitted within the 80 ms period. In addition, the MIB message includes parameters required by a terminal device to obtain the SIB1 message from a cell.

The SIB1 message may also be referred to as a message of SIB type 1. SIB1 is transmitted over a downlink shared channel (DL-SCH) with a period of 160 ms. Within the 160 ms period, SIB1 may be repeatedly transmitted with a variable repetition period. The default repetition period for SIB1 transmission is 20 ms, while the actual repetition period depends on network implementation. For example, in multiplexing pattern 1 of the synchronization signal block (SSB) and control resource set (CORESET), the repetition period of SIB1 transmission is 20 ms. However, in multiplexing pattern 2 or 3 of the SSB and CORESET, the repetition period of SIB1 transmission is the same as that of the SSB.

In the embodiments of the present application, SSB may also refer to a synchronization signal and physical broadcast channel block (synchronization signal and PBCH block).

SIB1 may carry key information required for a terminal device to access a cell, such as random access parameters. SIB1 also includes information related to the availability and scheduling of other SIBs, such as the mapping of other SIBs to system information (SI) messages, periodicity, and SI window size. SIB1 may further indicate whether one or more SIBs are provided only on demand. In such cases, SIB1 may also provide physical random access channel (PRACH) configuration information required by the terminal device to request the desired SI. SIB1 also contains radio resource configuration information common to all terminal devices and cell barring information used for unified access control.

When SIB1 includes information related to other SIBs, the other SIB messages may be provided by periodic broadcasting or on demand. If the other SIBs are provided on demand, SIB1 may further include information for a terminal device to perform an SI request.

SIB messages other than SIB1 (i.e., other SIBs) may be included in SI messages. These messages may also be transmitted over the DL-SCH. Each SI message may be transmitted periodically within a time-domain window (referred to as an SI window). For example, only SIBs with the same periodicity may be mapped to the same SI message. When each SI message is transmitted within a periodically occurring time domain window, all SI messages may have SI windows of the same length. Each SI message is associated with one SI window, and the SI windows of different SI messages do not overlap. That is, only the corresponding SI message is transmitted within one SI window. Additionally, the system may transmit the SI message multiple times within the SI window.

The foregoing description takes the system information in NR as an example to introduce various SIB messages. A network device (e.g., a gNB) may periodically transmit SIB1 for initial access and schedule other SIBs for terminal devices in an idle or inactive (also referred to as non-active) mode. Even in the absence of any request from terminal devices or when no terminal device is camped on the cell, the network device continues the transmission. Thus, in certain scenarios, the periodic transmission of SIB1 by the network device may result in significant energy waste.

In order to achieve network energy saving, it is necessary to reduce unnecessary SIB1 transmissions and the associated PRACH monitoring. Therefore, on-demand transmission of SIB1 for terminal devices in an idle or inactive mode has become a research direction, aiming to provide the network device with more opportunities to switch to a sleep mode. By way of example, how to implement on-demand SIB1 transmission to reduce the energy consumption of the network device is a technical challenge worthy of investigation.

In some embodiments, a cell in which SIB1 is transmitted on demand is referred to as an energy saving cell, e.g., a network energy saving (NES) cell. For a terminal device in an idle mode, since the NES cell does not include SIB1 information in the transmitted SSB, the terminal device needs to send corresponding request information/signaling to request the NES cell to transmit the SIB1 information.

Optionally, the request information for on-demand SIB1 may be a wake uplink signal (WUS), or other on-demand information/signaling for requesting the transmission of SIB1. The WUS is for an uplink to trigger the on-demand transmission of SIB1.

Optionally, the terminal device may transmit the request information triggering on-demand SIB1 over a random access channel (RACH) or a separate signal or sequence. For example, the terminal device may transmit the WUS over the PRACH.

For ease of understanding, a schematic illustration of the on-demand transmission of SIB1 is provided below, using WUS as an example, in conjunction with FIG. 2. In FIG. 2, the terminal device 210 is located within a cell A (Cell #A) served by the network device 220.

As shown in FIG. 2, the cell A periodically transmits SSBs that do not include SIB1, meaning that the cell A transmits SIB1 on demand. When a terminal device attempts to access the cell A which transmits SIB1 on demand, the terminal device may send an uplink WUS to trigger the transmission of SIB1 by the cell A. Upon detecting the WUS or on-demand request, the cell may transmit the on-demand SIB1 to the terminal device 210.

The above description, in conjunction with FIG. 2, introduces a method for transmitting on-demand SIB1 by request. For sending request information such as a WUS, the terminal device needs to obtain time-frequency resources for the WUS so as to transmit the WUS while in an idle or inactive state. However, how a terminal device in an idle or inactive state can obtain the time-frequency resources for request information such as the WUS is an issue that needs to be considered.

Regarding time-frequency resources, the following introduces a method for configuring time-frequency resources based on the control resource set (CORESET) and search space in the NR system. The CORESET primarily describes the frequency domain resource distribution, while the search space mainly describes the time domain resource distribution. Therefore, the pairing of CORESET and search space can determine the specific time-frequency resources.

In NR, the network side typically configures multiple CORESETs and search spaces within a bandwidth part (BWP). By pairing CORESETs with search spaces, one (block) or more time-frequency resources can be determined for different purposes.

For example, a one-to-one correspondence between CORESET and search space can be established. For instance, the time-frequency resources determined by a pair of CORESET and search space may be used to transmit downlink control information (DCI) format 0_0/1_0 (i.e., DCI_format 0_0/1_0), while another pair of CORESET and search space may be used to transmit DCI_format 0_1/1_1.

Alternatively, a one-to-many correspondence between CORESET and search space may also be established. For example, a single CORESET may correspond to multiple search spaces.

For example, search space 0 (Searchspace0) is configured for the MIB. The time-frequency resources determined by the pairing of search space 0 and CORESET 0 can be used by the terminal device to receive the remaining minimum system information (RMSI).

For example, the search spaces configured by the network side include the common search space (CSS) and the UE specific search space (USS). The search spaces configured by the network side, along with their associated CORESET configurations, can be used to determine the time-frequency resource scheduling of the physical downlink control channel (PDCCH). Furthermore, the PDCCH can be used to carry scheduling information for uplink or downlink data. The terminal device needs to periodically listen to the PDCCH to obtain uplink or downlink data scheduling information. The listening period may be one time slot.

For example, the specific types and applications of the search spaces are shown in Table 1.

TABLE 1

| Search space | Specific search space | Application scenario |
|---|---|---|
| classification | type | (example) |
| Common search | Type0-PDCCH CSS | SIB1 |
| space | Type0A-PDCCH CSS | Other system information |
| | Type1-PDCCH CSS | Message 2/Message 4 |
| | Type2-PDCCH CSS | Paging |
| | Type3-PDCCH CSS | Group Common DCI |
| UE specific | USS | Uplink or downlink |
| search space | | scheduling information |

As shown in Table 1, in the related art, the CSS primarily includes five types of search spaces. By way of example, the search space of Type 0 can be used to search for SIB1. The search space of Type OA can be used to search for other system information (OSI). The search space of Type 1 can be used to search for Message 2 (MSG2), Message 4 (MSG4), and the like. The search space of Type 2 can be used to search for Paging messages. The search space of Type 3 can be used to search for group common DCI.

With reference to Table 1, in the USS, the terminal device can detect whether the PDCCH contains scheduling information. Specifically, the downlink scheduling information may be physical downlink shared channel (PDSCH) resource scheduling information, while the uplink scheduling information may be physical uplink shared channel (PUSCH) resource scheduling information. For the downlink scheduling information, the terminal device can receive data via PDSCH based on the scheduling information. For the uplink scheduling information, the terminal device can transmit data via PUSCH based on the scheduling information. The PDCCH may also carry other control information, such as uplink power control command words and time slot formats. The PDCCH carrying different control information may use distinct radio network temporary identifiers (RNTIs) for scrambling.

For example, for USS, the base station can configure at least one search space set (SS set) for the terminal device. The terminal device can listen to the PDCCH according to the SS set. For instance, the terminal device can listen to the PDCCH according to the parameters of the SS set.

Typically, the terminal device only knows that the PDCCH will be transmitted within the resource block (RB) range provided by the CORESET, but does not know on which specific RBs the PDCCH will be transmitted. Therefore, the terminal device needs to perform PDCCH blind decoding across different search spaces or CORESETs, and the blind decoding process will only stop upon successful decoding. By way of example, the terminal device needs to search for PDCCH information according to different RNTI types. Furthermore, the terminal device continuously demodulates the PDCCH candidate set to obtain and determine the control channel element (CCE) index of each candidate PDCCH within the CORESET. The CCE index can be used to determine the start position and quantity of the CCEs. The specific CCE locations can also be determined using a search space function.

The above describes a method for the terminal device to determine system information or resource scheduling information via a search space. When the network device transmits SIB1 on demand, the MIB does not need to carry SIB1 information. In such a scenario, the configuration of the relevant search spaces is no longer applicable. For example, in an NES cell, the search space 0 or CORESET 0 of the MIB may be modified to accommodate the transmission requirements of the WUS.

In summary, since SIB1 is transmitted on demand, the WUS that triggers the transmission of SIB1 requires corresponding resource configuration information, so that the terminal device knows on which time-frequency resources to transmit the WUS. Therefore, how to configure the time-frequency resources for the WUS becomes a pressing technical problem to be solved.

It should be noted that the above mention of how the network device configures the time-frequency resources for the WUS is merely an example. The embodiments of the present application can be applied to the configuration of time-frequency resources for any type of information/signaling that triggers the on-demand transmission of SIB.

To address the above problem, a method for wireless communications is proposed in the embodiments of the present application. According to this method, the terminal device sends a first request for requesting a first SIB on a first resource, where the configuration information of the first resource is carried in the master information block (MIB). It can be seen that the network device configures new information in the MIB to indicate the first resource used for transmitting the first request. Once the configuration information of the first resource is set in the MIB, the terminal device can determine the time-frequency resources for the first request via the MIB, thereby triggering the transmission of the on-demand SIB1 from the energy saving cell.

For ease of understanding, the method proposed in the embodiments of the present application will be explained in detail below in conjunction with FIG. 3, which illustrates the method from the perspective of the interaction between the terminal device and the network device.

The terminal device refers to any terminal that can request on-demand SIB, and is not limited to a specific type. In some embodiments, the terminal device may be in an idle or inactive state. For example, the terminal device may be a UE in an idle/inactive mode.

For example, the terminal device is in an idle state. When performing initial access to an NES cell, the terminal device may request the network device serving the NES cell to transmit the on-demand SIB1, since the SSB transmitted by the NES cell does not include SIB1.

For example, the terminal device is in an inactive state. When recovering the connection to the NES cell, the terminal device can wake up the NES cell and request the network device serving the NES cell to transmit the on-demand SIB1.

In some embodiments, the terminal device may be a communications device that supports NES functionality. For example, in the case where the first SIB is not carried in the SSB or MIB, the terminal device can request the first SIB from the network device based on the NES functionality.

In some embodiments, the service cell corresponding to the terminal device is an energy saving cell. For example, the cell in which the terminal device is located is an NES cell. Taking FIG. 2 as an example, the Cell A is an NES cell, and the terminal device can be terminal device 210 in the Cell A.

For example, the cell in which the terminal device is located is an NTN cell. That is, the terminal device is a ground terminal in the NTN.

The network device can provide service to the cell in which the terminal device is located. The network device can be any network device described earlier, and is not limited in this regard. For example, the network device can be any base station as described earlier.

In some embodiments, the network device can be a communications device supporting NES functionality. For example, the network device can increase the sleep time of the service cell based on NES functionality. For example, the network device can implement an energy saving configuration for on-demand transmission of SIB1 from the cell.

For example, the network device can transmit SSBs periodically, where the SSB does not include configuration information for SIB1. For example, the network device can be a network device 220 in FIG. 2.

For example, the network device can transmit corresponding information or messages in different search spaces. For instance, the network device may indicate the resource information occupied by CORESET0 and search space 0 through configuration parameters in the MIB. The MIB does not carry information about SIB1.

For example, the network device can monitor the first request sent by the terminal device and respond to the first request accordingly. That is, even if the first cell is in sleep mode, the network device will still monitor the first request sent by the terminal device.

For example, the network device can receive the first request sent by the terminal device, which will be described in detail in Step S320.

For example, the cell served by the network device is an NTN cell. For example, the network device can be a satellite covering the area where the terminal device is located in the NTN, or a ground gateway or ground network device that communicates with the satellite in the NTN.

In some embodiments, the terminal device and network device can be relative terms. For example, a relay device can also be referred to as a terminal device relative to the network device. Similarly, relative to the terminal device, the relay device can also be referred to as a network device.

Referring to FIG. 3, in Step S310, the terminal device determines the configuration information of the first resource.

The first resource is used by the terminal device to send the first request for requesting the first SIB. The network device triggers the transmission of the first SIB at the terminal device's request. Therefore, the first SIB can also be referred to as the on-demand SIB. The detailed explanation will be provided in conjunction with Step S320.

Optionally, the first request may include the WUS described earlier, or include uplink information or signaling similar to the WUS functionality.

The first resource can be a time-frequency resource of any size, without limitation. In some embodiments, the first resource may include one or more time domain units. The time domain unit can be a symbol, a time slot, or a time domain segment of various lengths. In some embodiments, the first resource may include one or more frequency domain units. The frequency domain unit can be a frequency band of any length, e.g., a subcarrier.

The configuration information of the first resource can indicate the first resource. For example, the configuration information of the first resource can indicate the number of symbols occupied by the first resource, the start symbol position, etc. For example, the configuration information of the first resource can indicate the number of RBs occupied by the first resource.

The configuration information of the first resource can be carried in the MIB, so that a terminal device in idle or inactive states can timely determine the configuration information of the first resource. In some embodiments, the configuration information of the first resource is indicated by a configuration parameter in the MIB.

For example, the configuration parameter in the MIB may be pdcch-ConfigSIB1. The MIB can reuse an existing configuration parameter to indicate the configuration information of the first resource. For instance, the terminal device can detect the configuration information of the first resource in the search space indicated by this parameter.

For example, the high four bits of pdcch-ConfigSIB1 may represent CORESET0 (controlResourceSetZero), which can be used to obtain the CORESET0 format, the number of symbols occupied in the frequency domain resources, the number of RBs, and the RB offset. The low four bits may represent the search space 0, which can be used to obtain the system frame number (SFN), a time slot index, a start symbol, and other related information for CORESET0.

For example, the configuration parameter in the MIB may be pdcch-ConfigWUS. Thus, the MIB can add a new configuration parameter to indicate the configuration information of the first resource. For instance, the configuration information of the first resource can be indicated by pdcch-ConfigWUS. The terminal device can detect the configuration information of the first resource in the search space indicated by this parameter.

For example, the high four bits of pdcch-ConfigWUS may represent CORESET0, which can be used to obtain the CORESET0 format, the number of symbols occupied in the frequency domain resources, the number of RBs, and the RB offset. The low four bits of pdcch-ConfigWUS may represent the search space 0, which can be used to obtain the SFN, the time slot index, the start symbol, and other related information for CORESET0.

In a possible implementation, the time-frequency resource information for the WUS can be configured in the parameter pdcch-ConfigWUS.

In some embodiments, the configuration information of the first resource can be carried in the SSB transmitted by the network device.

In some embodiments, the configuration information of the first resource can be in the first search space. That is, the terminal device can detect the configuration information of the first resource in the first search space. Therefore, the first search space is the search space for the first request (WUS). For example, the terminal device can detect the PDCCH in the first search space to determine the configuration information of the first resource. In other words, the configuration information of the first resource is indicated by the PDCCH in the first search space.

It should be understood that the terminal device performing detection in the search space can be considered as the terminal device performing listening, monitoring, or searching within the search space. The detection performed by the terminal device in the search space can include the PDCCH blind decoding described earlier.

In some embodiments, the first search space may be any search space in the common search space (CSS), or a specific search space corresponding to the terminal device. Optionally, the specific search space corresponding to the terminal device may belong to the UE specific search space (USS) described earlier. The specific search space corresponding to the terminal device may also be referred to as proprietary search space or dedicated search space for the terminal device.

Optionally, the search space corresponding to the WUS may be in the common search space or may be configured in the proprietary search space for the terminal device.

For example, the first search space is the common search space, the terminal device can perform detection or listening within the common search space according to the configuration of the network device to determine the configuration information of the first resource. By way of example, the terminal device can determine the first search space from multiple search spaces based on the type of the first search space, and then detect the configuration information of the first resource in the first search space.

For example, the first search space is a specific search space corresponding to the terminal device, and the network device configures the relevant parameters of this specific search space. These relevant parameters may include a search space identity (ID), a monitoring period, a symbol position, and so on.

For example, within the specific search space of the terminal device, the network device or the terminal device can set a specific symbol position within each time slot for monitoring the configuration information of the first resource. By way of example, the symbol positions at which the monitoring will be performed can be several consecutive symbols. Alternatively, the symbol positions at which the monitoring will be performed can be set according to odd and even symbols, or in a regular pattern.

In some embodiments, the type of the first search space can be an existing search space type. For example, the type of the first search space can be one of the search space types mentioned in Table 1. Optionally, since the first resource is used to send request information triggering the on-demand SIB1, the first search space can be one of the search spaces used for sending SIB1 as listed in Table 1. That is, in an NES cell, the first search space configured by the network side can replace the search space originally configured for SIB1.

For example, the type of the first search space can be Type0-PDCCH CSS, as detailed in the first embodiment.

For example, when the search space corresponding to the first SIB is the second search space, the search space type of the first search space is the same as the search space type of the second search space. For example, the search space used for WUS and the search space used for SIB1 have the same search space type.

For example, the first search space can directly adopt the search space configured by the network side for SIB1. For example, the first search space can be used to send the configuration information of the first resource and/or the first SIB, i.e., the first search space is the same as the second search space. In these scenarios, the first search space may transmit both WUS and SIB1 simultaneously, distinguishing the PDCCH by distinct scrambling.

For example, the network side can periodically configure multiple search spaces, including the first search space. The network side can send the configuration information of the first resource in the first search space during the current period, and send the first SIB in the corresponding first search space during the next period.

For example, when the first request is WUS, PDCCH-configWUS can be indicated by PDCCH-configcommon: the search space for WUS replaces the original search space for SIB1.

In some embodiments, the network side can set a new search space for the resource of the first request. That is, the first search space used to send the first request is of a newly configured search space type, without reusing an existing search space type. For example, when the first search space used for the first request belongs to a first type of search space and the second search space used for the first SIB belongs to a second type of search space, the first type and the second type are distinct. Furthermore, the first type of search space is a dedicated search space related to the first request.

For example, the type of the first search space can be Type0B-PDCCH CSS, as detailed in the second embodiment.

For example, after the terminal device sends the uplink WUS in idle/inactive mode, the NTN can transmit the SIB1 information in the next period or within the time specified by the protocol.

For example, PDCCH-configcommon in the MIB can indicate that the original search space for SIB1 can be reserved for the on-demand SIB1 (first SIB). In the case of supporting on-demand SIB1, the network device still sends the on-demand SIB1 through the MIB, and a new search space Type0B-PDCCH CSS is configured to support the resource configuration information for WUS.

As described above, the type of the first search space for the first request can be either an existing type or a newly configured type. Below, using WUS as an example, two possible implementations will be illustratively explained in conjunction with Table 2.

TABLE 2

| Search space | Specific search space | Schematic application |
|---|---|---|
| classification | type | scenario |
| Common search | Type0-PDCCH CSS | SIB1 or WUS (first |
| space | | embodiment) |
| | | SIB1 (second embodiment) |
| | Type0A-PDCCH CSS | Other system information |
| | Type0B-PDCCH CSS | WUS (second embodiment) |
| | Type1-PDCCH CSS | Message 2/Message 4 |
| | Type2-PDCCH CSS | Paging |
| | Type3-PDCCH CSS | Group Common DCI |
| UE specific | USS | Uplink or downlink |
| search space | | scheduling information |

As shown in Table 2, in the first embodiment, the type of the first search space for WUS is the existing search space type used for SIB1, namely Type0-PDCCH CSS. Based on this embodiment, the network side can continue using the existing search space setup method, only indicating in the configuration information whether the resources for the current period are used to send the configuration information for the first resource or SIB1. In the second embodiment, the type of the first search space for WUS is the newly configured Type0B-PDCCH CSS. Based on this embodiment, the newly configured search space can avoid conflicts between the WUS search space and the existing search spaces, better accommodating scenarios where both on-demand SIB1 and WUS are sent simultaneously within the same period.

In some embodiments, the first SIB can be configured on a specific search space corresponding to the terminal device, and the specific search space can be determined by parameters in the radio resource control (RRC). For example, the network device can configure a dedicated search space for the terminal device. The terminal device can determine its dedicated search space based on parameters in the RRC message.

For example, when the first SIB is transmitted on a specific search space, the second search space may be one of multiple specific search spaces.

For example, when the second search space is specific to the terminal device, the network device can configure related parameters of the second search space. These related parameters may include the search space ID, the monitoring cycle, the symbol positions, and so on.

For example, within the search space specific to the terminal device, the network device or the terminal device can set the symbol positions, within each time slot, at which the first SIB is to be monitored. By way of example, the symbol positions at which the monitoring can be performed may by several consecutive symbols. Alternatively, the symbol positions at which the monitoring can be performed may be configured according to odd and even symbols, or in a predefined pattern.

For example, the search space specific to the terminal device can be dynamically adjusted based on network requirements and the capabilities of the terminal device. For instance, the network device can dynamically adjust the search space specific to the terminal device in real time based on the terminal capability information and the actual communication needs.

The determination of the configuration information of the first resource by the terminal device may include the terminal device receiving the configuration information of the first resource transmitted by the network device. In other words, the configuration information of the first resource may be detected by the terminal device in a search space or may be directly received by the terminal device.

For example, the terminal device can determine the first resource based on the resource configuration information of WUS detected by the terminal device in the first search space. Upon determining the first resource, the terminal device can send the first request on the determined first resource.

With reference to FIG. 3, in Step S320, the terminal device sends the first request on the first resource. As described above, the first request is used by the terminal device to request the first SIB from the network device.

In some embodiments, the first SIB refers to one or more SIBs transmitted by the network device at the terminal device's request. It can be seen that the network device does not need to transmit the first SIB periodically, but instead transmits the first SIB on demand, thereby achieving energy saving. For example, the network device does not need to transmit SIB1 in accordance with a 160 ms periodicity and a transmission repetition period within the 160 ms, but rather transmits SIB1 at the first request.

In some embodiments, the first SIB includes SIB1. The network device may transmit SIB1 at a request from the terminal device, thereby reducing unnecessary SIB1 transmissions. For example, the first SIB may include SIB1 within the serving cell and other SIBs. In other words, the first SIB may represent a subset of SIBs within the serving cell that includes SIB1.

In some embodiments, the first SIB is the on-demand SIB1 described above. That is, the first SIB may be SIB1.

In some implementations, when the serving cell is an NES cell, the transmitted SSB may not include the parameter set for SIB1, thereby reducing transmission overhead. However, certain configurations for random access to the cell are provided in SIB1. When detecting the serving cell and intends to access the serving cell, the terminal device needs to request the first SIB since the received SSB does not include SIB1 parameters.

In some embodiments, the first SIB is the SIB required by the terminal device, and the first request may also be referred to as an on-demand SIB request.

In some embodiments, the network device may transmit the first SIB at different times in the second search space. When detecting the first SIB within the second search space, the terminal device needs to perform blind decoding over multiple time-frequency resources in the second search space.

It should be understood that the detection of the first SIB by the terminal device in the second search space may include detecting information related to the first SIB. When the time-frequency resources in the second search space are used to directly transmit the first SIB, the terminal device may directly monitor the first SIB in the second search space. When the time-frequency resources in the second search space are used to transmit information related to the first SIB, the terminal device detects the related information and subsequently receives the first SIB.

In some embodiments, the first SIB may be transmitted using at least one of multiple time-frequency resources. To facilitate the terminal device in determining the transmission resources of the first SIB, the network device may associate the time-frequency resources of the first SIB with a synchronization signal block (SSB) index. In other words, the SSB index received by the terminal device may be associated with the first SIB.

For example, within the second search space, the resources in the search space may be identified respectively based on distinct SSB indexes, so as to distinguish the specific time-frequency resource information corresponding to different SSB indexes. These time-frequency resources may include multiple resources used for transmitting the first SIB. Accordingly, the first SIBs transmitted by the network device at different time instances may correspond to different SSB indexes, for the terminal device to determine the time-frequency resources of the first SIB based on the received SSB index, and therefore timely receive the first SIB.

For example, the terminal device may determine at least one time-frequency resource for transmitting the first SIB based on the index of the received SSB. Thereafter, the terminal device may receive the first SIB on the at least one time-frequency resource.

For example, multiple time-frequency resources may correspond one-to-one with multiple SSBs, so as to more flexibly indicate the time-frequency resources of the first SIB. For instance, the indexes of the multiple time-frequency resources may respectively correspond to the indexes of the multiple SSBs.

For example, any of the multiple time-frequency resources may correspond to multiple SSBs, to accommodate scenarios where a one-to-one correspondence is not required, thereby reducing signaling overhead. For instance, the index of a single time-frequency resource may correspond to indexes of multiple SSBs.

Optionally, the one-to-many correspondence between the multiple time-frequency resources and the multiple SSBs may be any of the following: one time-frequency resource corresponds to two SSBs, one time-frequency resource corresponds to four SSBs, one time-frequency resource corresponds to eight SSBs, and so on.

In an embodiment, a single time-frequency resource for transmitting the first SIB may be applicable to indexes of multiple received SSB, particularly in scenarios where the terminal device has a low mobility or where the surrounding environment changes slowly. This is especially applicable in NTN scenarios, where the signal strength differences among different SSBs received by the terminal device are minimal. In such cases, the first SIB transmitted over the time-frequency resource may correspond to all SSBs within a single SSB time window.

In another embodiment, in scenarios where the terminal device has high mobility or the surrounding environment is complex, the SSB transmission window may be divided into multiple sub-time windows. Each sub-time window may correspond to indexes of multiple SSB, and the first SIB transmitted over a given time-frequency resource may correspond to indexes of all SSB within the sub-time window.

For example, multiple time-frequency resources may correspond to any of the multiple SSBs. For instance, the indexes of multiple time-frequency resources may correspond to the index of a single SSB. Optionally, the one-to-many correspondence between the multiple time-frequency resources and the multiple SSBs may be any of the following: two time-frequency resources correspond to one SSB, four time-frequency resources correspond to one SSB, eight time-frequency resources correspond to one SSB, and so on.

For example, in the case of frequency range 2 (FR2), the network device and the terminal device can determine, based on the aforementioned correspondence, which SSB index on which beam the first SIB will correspond to.

For example, the SSB index within an SSB transmission window may correspond to the on-demand SIB1 and the corresponding preamble in the on-demand SIB1. The on-demand SIB1 may refer to the time-frequency resources of the on-demand SIB1. The correspondence between the SSB index and time-frequency resources of the on-demand SIB1 may be one-to-one, or may not be one-to-one. As mentioned earlier, one SSB index may correspond to one or more time-frequency resources for the first SIB. Alternatively, multiple SSB indexes may correspond to a single time-frequency resource for the first SIB.

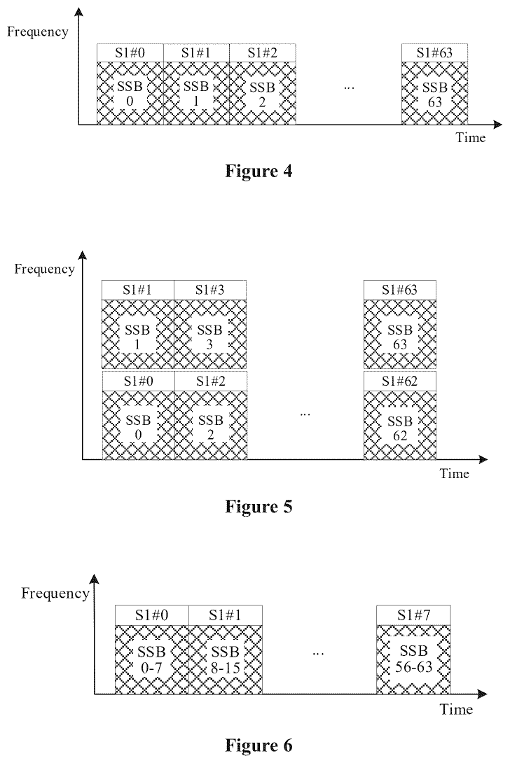

For ease of understanding, the correspondence between the SSB index and time-frequency resources of the on-demand SIB1 will be exemplified with reference to FIGS. 4 to 7. In FIGS. 4 to 7, the network device transmits 64 SSBs, labeled SSB0 to SSB63. The multiple time-frequency resources for transmitting the on-demand SIB1 are represented as S1 #0, S1 #1, S1 #2, and so on.

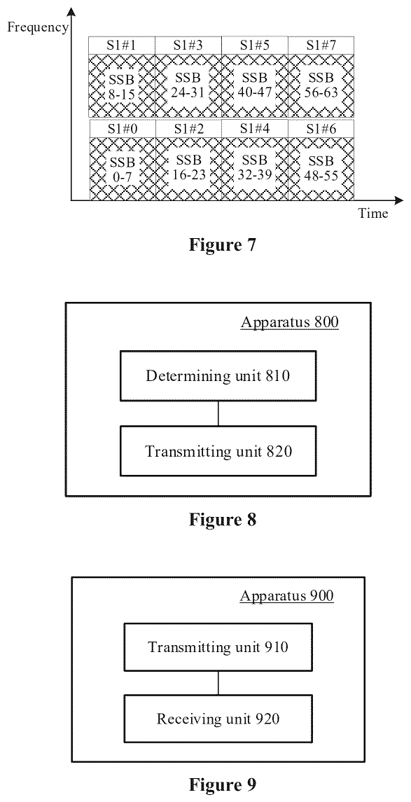

In FIGS. 4 and 6, the multiple SSB indexes correspond to multiple SSBs, occupying distinct time-domain resources. In FIGS. 5 and 7, the multiple SSBs corresponding to multiple SSB indexes share time frequency, that is, two SSBs within the same time-domain resource occupy distinct frequency-domain resources.

In FIGS. 4 and 5, there is a one-to-one correspondence between the multiple time-frequency resources for the on-demand SIB1 and the multiple SSB indexes. As shown in FIGS. 4 and 5, time-frequency resources for the 64 on-demand SIB1 corresponding to the 64 SSB indexes are indexed from S1 #0 to S1 #63.

In FIGS. 6 and 7, the correspondence between the SSB indexes and time-frequency resources for the on-demand SIB1 has a many-to-one correspondence. As shown in FIGS. 6 and 7, in this many-to-one correspondence, 8 SSB indexes correspond to the time-frequency resource for one on-demand SIB1. Therefore, time-frequency resources for the 64 on-demand SIB1 corresponding to the 64 SSB indexes are indexed from S1 #0 to S1 #7.

The above description, with reference to FIGS. 4 through 7, illustrates various implementations of the time-frequency resources for the first SIB corresponding to the SSB. Regardless of the implementation, the time-frequency resources for transmitting the first SIB may belong to either the common search space or the specific search space, with no limitation imposed.

The first request can be implemented in various ways. That is, the first terminal device may send information to request the first SIB in multiple manners. Optionally, the first request may include one or more of the following: WUS, demand information or demand signaling to request the first SIB, a first sequence for requesting the first SIB, or a preamble index related to the first SIB.

For example, the demand signaling may be control signaling or data signaling, with no limitation imposed here.

In some embodiments, after transmitting the first request, the terminal device may detect the first SIB in a second search space. Upon receiving the first request from the terminal device, the network device may transmit the first SIB in the second search space so that the terminal device can receive the first SIB.

The foregoing description, with reference to FIGS. 3 to 7, illustrates two embodiments: one where the configuration information of the first resource reuses an existing search space, and another where a new search space is configured for the first resource. Regardless of the type of the first search space for the first resource, the time-frequency resource for transmitting the first SIB may have a correspondence with the SSB. Therefore, the terminal device can determine the time-domain position for receiving the first SIB based on the received SSB.

In some embodiments, the terminal device detects the PDCCH in the first search space or the second search space. The PDCCH may indicate the configuration information of the first resource or the first SIB. For example, the PDCCH may indicate information related to the first SIB. It should be understood that the PDCCH is merely an example, and other channels or signals may be used to indicate the configuration information of the first resource or the first SIB.

As described above, the terminal device does not know on which RBs within the CORESET the PDCCH will be transmitted. Therefore, the terminal device needs to perform a blind decoding procedure to locate the desired PDCCH. In order to reduce or avoid the blind decoding process in the search space, the embodiments of the present application further propose an approach for directly locating the PDCCH. By this approach, the terminal device can directly locate the PDCCH within the CORESET, thereby more rapidly determining the time-frequency resource for transmitting the first request or determining the first SIB, which improves decoding efficiency.

In some embodiments, the control resource set (CORESET) corresponding to the PDCCH that indicates the configuration information of the first resource or the first SIB may be a first control resource set (i.e., first CORESET). The position of the PDCCH in the first CORESET may be related to one or more of the following information: a start symbol position of the first CORESET; the number of resource blocks (RB) occupied by each CCE in the first CORESET; the number of symbols or RBs covered by the first CORESET; the number of CCEs included in the PDCCH; or an ID of the terminal device.

For example, the start symbol of the first CORESET is the first symbol of the time-domain resources occupied by the first CORESET.

For example, the number of RBs occupied by each CCE in the first CORESET can be determined according to the protocol or dynamically indicated.

For example, the number of symbols or RBs covered by the first CORESET is determined when being configured on the network side.

For example, the number of CCEs included in the PDCCH may also be referred to as the number of CCEs corresponding to the terminal device in the CORESET.

Optionally, the start position of the PDCCH in the first CORESET can be determined based on the ID of the terminal device and the number of CCEs included in the PDCCH. It is assumed that the PDCCH includes N_{CCE} CCEs, where N_{CCE} is a positive integer. The start position of the PDCCH in the first CORESET can be indicated by an index of a start CCE among the N_{CCE} CCEs. The index of the start CCE can be denoted as CCE_{Index}=UE_{ID} mod N_{CCE}. UE_{ID} is the ID of the terminal device.

Optionally, the symbol position of the PDCCH in the first CORESET can be determined based on the start symbol of the first CORESET, the ID of the terminal device, and the number of symbols covered by the first CORESET. It is assumed that the first CORESET covers M symbols, where M is a positive integer. The symbol position PDCCH_{symbol,position} of the PDCCH in the first CORESET can be denoted as PDCCH_{symbol,position}=S₀+(UE_{ID} mod M). S₀ is the start symbol position of the first CORESET.

Optionally, the frequency domain position of the PDCCH in the first CORESET can be determined based on the number of RBs occupied by each CCE, the index of the start CCE, and the number of RBs covered by the first CORESET. The frequency domain position PDCCH_{frequency,position} of the PDCCH in the first CORESET can be denoted as PDCCH_{frequency,position}=(CCE_{Index}×CCE_{Size}) mod N_{RB}. CCE_{Size} is the number of RBs occupied by each CCE, and is a positive integer. N_{RB} is the number of RBs covered by the first CORESET, and is a positive integer.

The foregoing describes the method embodiments of the present application in detail with reference to FIGS. 1 to 7. The apparatus embodiments of the present application will now be described in detail with reference to FIGS. 8 to 10. It should be understood that the descriptions of the apparatus embodiments correspond to those of the method embodiments. Therefore, for context not described in detail here, reference may be made to the foregoing method embodiments.

FIG. 8 is a schematic block diagram of an apparatus for wireless communications according to an embodiment of the present application. The apparatus 800 may be any terminal device as described above. The apparatus 800 shown in FIG. 8 includes a determining unit 810 and a transmitting unit 820.

The determining unit 810 is configured to determine configuration information of a first resource.

The transmitting unit 820 is configured to transmit the first request on the first resource. The configuration information of the first resource is carried in a master information block, and the first request is used to request a first SIB.

Optionally, the first request includes WUS, and the configuration information of the first resource is indicated by pdcch-ConfigWUS in the master information block.

Optionally, the determining unit is further configured to detect the configuration information of the first resource in the first search space. The first search space is either a common search space or a search space specific to the terminal device.

Optionally, the search space corresponding to the first SIB is a second search space, and the apparatus 800 further includes a first detecting unit for detecting the first SIB in the second search space after the first request is transmitted.

Optionally, the search space type corresponding to the first search space is the same as the search space type corresponding to the second search space.

Optionally, the first search space belongs to the first type of search space, and the second search space belongs to the second type of search space, where the first type is different from the second type. The first type of search space is a dedicated search space for the first request.

Optionally, the first SIB is transmitted on at least one of the multiple time-frequency resources, and the determining unit 810 is further configured to determine at least one time-frequency resource based on the index of the received synchronization signal block. The apparatus 800 further includes a receiving unit, for receiving the first SIB on at least one time-frequency resource.

Optionally, multiple time-frequency resources correspond one-to-one with multiple synchronization signal blocks. Alternatively, any time-frequency resource of the multiple time-frequency resources corresponds to multiple synchronization signal blocks.

Optionally, the first SIB is located on the search space specific to the terminal device, which is determined by parameters in RRC.

Optionally, the apparatus 800 further includes a second detecting unit, for detecting the PDCCH in the first search space or the second search space. The PDCCH indicates the configuration information of the first resource or the first SIB.

Optionally, the PDCCH corresponds to a first control resource set. The position of the PDCCH in the first control resource set is related to one or more of the following information: a start symbol position of the first control resource set; the number of RBs occupied by each CCE in the first control resource set; the number of symbols or RBs covered by the first control resource set; the number of CCEs included in the PDCCH; or an ID of the terminal device.

Optionally, the PDCCH includes N_{CCE} CCEs, where N_{CCE} is a positive integer. The start position of the PDCCH in the first control resource set can be indicated by an index CCE_{Index} of a start CCE among the N_{CCE} CCEs. The index of the start CCE can be denoted as CCE_{Index}=UE_{ID} mod N_{CCE}. UE_{ID} is the ID of the terminal device.

Optionally, the symbol position PDCCH_{symbol,position} of the PDCCH in the first CORESET can be denoted as PDCCH_{symbol,position}=S₀+(UE_{ID} mod M). S₀ is the start symbol position of the first CORESET. M is the number of symbols covered by the first control resource set, and is a positive integer.

Optionally, the frequency domain position PDCCH_{frequency,position} of the PDCCH in the first control resource set can be denoted as PDCCH_{frequency,position}=(CCE_{Index}×CCE_{Size}) mod N_{RB}. CCE_{Size} is the number of RBs occupied by each CCE, and is a positive integer. N_{RB} is the number of RBs covered by the first control resource set, and is a positive integer.

Optionally, the first SIB includes SIB1, and the terminal device is in idle or non-activated mode.

FIG. 9 is a schematic block diagram of an apparatus for wireless communications according to the embodiment of the present application. The apparatus 900 can be any network device described earlier. The apparatus 900 shown in FIG. 9 includes a transmitting unit 910 and a receiving unit 920.

The transmitting unit 910 is configured to transmit configuration information of a first resource.

The receiving unit 920 is configured to receive a first request sent by a terminal device on the first resource. The configuration information of the first resource is carried in the master information block, and the first request is used to request a first SIB.

Optionally, the first request includes WUS, and the configuration information of the first resource is indicated by pdcch-ConfigWUS in the master information block.

Optionally, the configuration information of the first resource is sent through a first search space. The first search space is either a common search space or a search space specific to the terminal device.

Optionally, the search space corresponding to the first SIB is the second search space. The transmitting unit is further configured to, after receiving the first request, send the first SIB on the second search space.

Optionally, the search space type corresponding to the first search space is the same as that corresponding to the second search space.

Optionally, the first search space belongs to the first type of search space, and the second search space belongs to the second type of search space, where the first type is different from the second type. The first type of search space is a dedicated search space for the first request.

Optionally, the first SIB is transmitted on at least one of the multiple time-frequency resources. The apparatus 900 further includes a determining unit, for determining at least one time-frequency resource based on an index of a synchronization signal block received by the terminal device. The transmitting unit 910 is further configured to send the first SIB on the at least one time-frequency resource.

Optionally, multiple time-frequency resources correspond one-to-one with multiple synchronization signal blocks. Alternatively, any time-frequency resource of the multiple time-frequency resources corresponds to multiple synchronization signal blocks.

Optionally, the first SIB is located on the search space specific to the terminal device, which is determined by parameters in RRC.

Optionally, the transmitting unit 910 is further configured to transmit PDCCH on the first search space or the second search space. The PDCCH indicates the configuration information of the first resource or the first SIB.

Optionally, the PDCCH corresponds to a first control resource set. The position of the PDCCH in the first control resource set is related to one or more of the following information: a start symbol position of the first control resource set; the number of RBs occupied by each CCE in the first control resource set; the number of symbols or RBs covered by the first control resource set; the number of CCEs included in the PDCCH; or an ID of the terminal device.

Optionally, the PDCCH includes N_{CCE} CCEs, where N_{CCE} is a positive integer. The start position of the PDCCH in the first control resource set can be indicated by an index CCE_{Index} of a start CCE among the N_{CCE} CCEs. The index of the start CCE can be denoted as CCE_{Index}=UE_{ID} mod N_{CCE}. UE_{ID} is the ID of the terminal device.

Optionally, the symbol position PDCCH_{symbol,position} of the PDCCH in the first CORESET can be denoted as PDCCH_{symbol,position}=S₀+(UE_{ID} mod M). S₀ is the start symbol position of the first CORESET. M is the number of symbols covered by the first control resource set, and is a positive integer.

Optionally, the frequency domain position PDCCH_{frequency,position} of the PDCCH in the first control resource set can be denoted as PDCCH_{frequency,position}=(CCE_{Index}×CCE_{Size}) mod N_{RB}. CCE_{Size} is the number of RBs occupied by each CCE, and is a positive integer. N_{RB} is the number of RBs covered by the first control resource set, and is a positive integer.

Optionally, the first SIB includes SIB1, and the terminal device is in idle or non-activated mode.

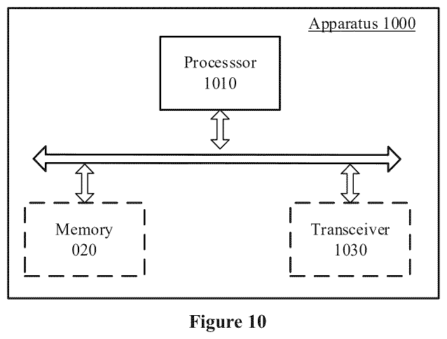

FIG. 10 is a structural diagram of a communications apparatus according to the embodiments of the present application. The dashed lines in FIG. 10 indicate that the unit or module is optional. The apparatus 1000 can perform the method described in the aforementioned method embodiments. The apparatus 1000 can be a chip, a terminal device, or a network device.

The apparatus 1000 may include one or more processors 1010. The processor 1010 can support the apparatus 1000 to perform the method described in the previous method embodiments. The processor 1010 can be a general-purpose processor or a dedicated processor. For example, the processor can be a central processing unit (CPU). Alternatively, the processor may also be another general-purpose processor, a digital signal processor (DSP), an application-specific integrated circuit (ASICs), a field-programmable gate arrays (FPGA), or other programmable logic devices, a discrete gate or transistor logic device, a discrete hardware component, etc. A general-purpose processor may be a microprocessor or any conventional processor, etc.

The apparatus 1000 may also include one or more memories 1020. The memory 1020 stores a program that can be executed by the processor 1010, enabling the processor 1010 to perform the method described in the previous method embodiments. The memory 1020 can be independent of the processor 1010 or integrated within the processor 1010.

The apparatus 1000 may further include a transceiver 1030. The processor 1010 can communicate with other devices or chips via the transceiver 1030. For example, the processor 1010 can send date to or receive data from other devices or chips through the transceiver 1030.

The present application further provides a computer-readable storage medium for storing a program. The computer-readable storage medium can be applied to the terminal device or the network device provided in the embodiments of the present application, and the program enables a computer to perform the method performed by the terminal device or the network device as described in the various embodiments of the present application.

The computer-readable storage medium can be any available medium that can be read by a computer, or a data storage device such as a server or data center that integrates one or more available media. The available media can be magnetic media (e.g., floppy disks, hard disks, tapes), optical media (e.g., digital versatile discs (DVD)), or semiconductor media (e.g., solid-state drives (SSD)), etc.

The present application further provides a computer program product. The computer program product comprises a program. The computer program product may be applied to the terminal device or the network device provided in the embodiments of the present application, and the program causes a computer to perform the method performed by the terminal device or the network device as described in the various embodiments of the present application.

The foregoing embodiments of the present application may be implemented in whole or in part by software, hardware, firmware, or any combination thereof. When implemented in software, the embodiments may be embodied in whole or in part as a computer program product. The computer program product comprises one or more computer instructions. The computer program instructions, when being loaded onto and executed by a computer, cause the computer to perform all or part of the processes or functions described in the embodiments of the present application. The computer may be a general-purpose computer, a dedicated computer, a computer network, or other programmable device. The computer instructions may be stored on a computer-readable storage medium or transmitted from one computer-readable storage medium to another. For example, the computer instructions may be transmitted from one website, computer, server, or data center to another website, computer, server, or data center over a wired medium (e.g., a coaxial cable, an optical fiber, a digital subscriber line (DSL)) or a wireless medium (e.g., infrared, radio, microwave, etc.).

The present application further provides a computer program. The computer program may be applied to the terminal device or network device provided in the embodiments of the present application, and the computer program causes a computer to perform the method performed by the terminal device or network device as described in various embodiments of the present application.

The terms “system” and “network” as used herein may be used interchangeably. Furthermore, the terminology used in the present application is intended solely to describe particular embodiments of the present application and is not intended to limit the scope of the present application. The terms “first,” “second,” “third,” “fourth,” and the like as used in the description and claims of the present application and in the accompanying drawings are intended to distinguish different objects and are not intended to indicate any particular order. In addition, the terms “include” and “have” as well as any variations thereof are intended to cover non-exclusive inclusion.

In the embodiments of the present application, the term “indicate” may refer to a direct indication, an indirect indication, or an indication of an association. For example, “A indicates B” may mean: that A directly indicates B, e.g., B being obtainable from A; that A indirectly indicates B, e.g., A indicating C and B being obtainable from C; or that A and B are associated.

In the embodiments of the present application, the term “correspond” may refer to a direct or indirect correspondence between two entities, an association between them, or a relationship such as one indicating or being indicated by the other, or one being configured with or by the other.

In the embodiments of the present application, the terms “predefined” or “preconfigured” can be realized by pre-storing corresponding codes, tables, or other forms in devices (e.g., including terminal devices and network devices) to indicate the relevant information. The application does not limit the specific implementations. For example, “predefined” can refer to definitions in the protocol.

In the embodiments of the present application, the term “protocol” may refer to a standard protocol in the communication field, for example, including the LTE protocol, the NR protocol, or protocols applicable to future communication systems, without limitation thereto.

In the embodiments of the present application, “determining B based on A” does not imply determining B solely based on A. Instead, B may be determined based on A and/or other information.

In the embodiments of the present disclosure, the term “and/or” is merely used to describe an association between related objects, indicating that three types of relationships may exist. For example, “A and/or B” may refer to: only A, both A and B, or only B. Additionally, the character “/” generally denotes an “or” relationship between the related objects preceding and following it.

In the embodiments of the present disclosure, the numerical labels assigned to the above-mentioned steps do not necessarily indicate the sequence of execution. The sequence of execution of the steps should be determined based on their functions and inherent logic, and should not be construed as a limitation on the implementation process of the embodiments of the present disclosure.

In the several embodiments provided in the present disclosure, it should be understood that the disclosed systems, apparatus, and methods may be implemented in other manners. For example, the apparatus embodiments described above are merely illustrative. The division of the units is only one example of logical functional division. In actual implementation, other forms of division may be adopted. For example, multiple units or components may be combined or integrated into another system, or some features may be omitted or not performed. Additionally, the couplings or direct couplings or communication connections shown or discussed between modules may be indirect couplings or communication connections through some interfaces, devices, or units, and such connections may be electrical, mechanical, or of other types.

The units described as separate components may or may not be physically separated, and the component displayed as a unit may or may not be a physical unit. That is, the units may be located in one place or distributed across multiple network units. Some or all of the units may be selected as needed to achieve the objectives of the embodiments of the present disclosure.

In addition, the functional units in various embodiments of the present disclosure may be integrated into one processing unit, or each unit may exist independently in a physical form, or two or more units may be integrated into one unit.

The foregoing description merely illustrates specific embodiments of the present application and should not be construed as limiting the scope of protection of the present application. Any variations or substitutions readily conceived by those skilled in the art within the scope of the technical disclosure of the present application shall fall within the scope of protection of the present application. Therefore, the scope of protection of the present application shall be defined by the claims.

What is claimed is:

1. A method for wireless communications, comprising:
receiving, by a terminal device in an NES (network energy saving) cell, configuration information of a first resource; and
transmitting, by the terminal device, a first request on the first resource,
wherein the configuration information of the first resource is carried in a master information block, and the first request is used for requesting an on-demand first system information block (SIB1).

2. The method according to claim 1, wherein the first request comprises a wake uplink signal (WUS), and the configuration information of the first resource is indicated by pdcch-ConfigWUS in the master information block.

3. The method according to claim 1, wherein the receiving the configuration information of the first resource comprises:
detecting, by the terminal device, the configuration information of the first resource in a first search space,
wherein the first search space is a common search space or a search space specific to the terminal device.

4. The method according to claim 3, wherein the on-demand SIB1 corresponds to a second search space, and the method further comprises:
detecting, by the terminal device after transmitting the first request, the on-demand SIB1 in the second search space.

5. The method according to claim 4, wherein a type of the first search space is the same as a type of the second search space.

6. The method according to claim 4, wherein the first search space belongs to a first type of search space, the second search space belongs to a second type of search space, the first type is different from the second type, and the first type of search space is a dedicated search space related to the first request.

7. The method according to claim 1, wherein the on-demand SIB1 is received on at least one time-frequency resource among a plurality of time-frequency resources, and the method further comprises:
determining, by the terminal device, the at least one time-frequency resource based on an index of a received synchronization signal block; and
receiving, by the terminal device, the on-demand SIB1 on the at least one time-frequency resource.

8. The method according to claim 7, wherein the plurality of time-frequency resources and a plurality of synchronization signal blocks are in a one-to-one correspondence, or a time-frequency resource among the plurality of time-frequency resources corresponds to a plurality of synchronization signal blocks.

9. The method according to claim 1, wherein the on-demand SIB1 is located in a search space specific to the terminal device, and the search space specific to the terminal device is determined based on a parameter in radio resource control (RRC).

10. The method according to claim 1, further comprising:
detecting, by the terminal device, a physical downlink control channel (PDCCH) in a first search space or second search space,
wherein the PDCCH indicates the configuration information of the first resource or the on-demand SIB1.

11. The method according to claim 10, wherein the PDCCH corresponds to a first control resource set, and a position of the PDCCH in the first control resource set is related to one or more of the following:
a start symbol position of the first control resource set;
a quantity of resource blocks (RBs) occupied by each control channel element (CCE) in the first control resource set;
a quantity of symbols or RBs covered by the first control resource set;
a quantity of CCEs comprised in the PDCCH; or
an identifier (ID) of the terminal device.

12. The method according to claim 11, wherein the PDCCH comprises N_{CCE} CCEs, N_{CCE} being a positive integer, and a start position of the PDCCH in the first control resource set is indicated by an index CCE_{Index} of a start CCE, and the index CCE_{Index} is denoted as CCE_{Index}=UE_{ID} mod N_{CCE}, wherein UE_{ID} is the ID of the terminal device.

13. The method according to claim 11, wherein a symbol position of the PDCCH in the first control resource set is denoted as PDCCH_{symbol,position}=S₀+(UE_{ID} mod M), wherein S₀ is the start symbol position of the first control resource set, and M is the quantity of symbols covered by the first control resource set and is a positive integer.

14. The method according to claim 11, wherein a frequency domain position of the PDCCH in the first control resource set is denoted as PDCCH_{frequency,position}=(CCE_{Index}×CCE_{Size}) mod N_{RB}, wherein CCE_{Size} is the quantity of RBs occupied by each CCE and is a positive integer, and N_{RB} is the quantity of RBs covered by the first control resource set and is a positive integer.

15. The method according to claim 1, wherein the terminal device is in an idle state or a non-active state.

16. A method for wireless communications, comprising:
transmitting, by a network device in an NES (network energy saving) cell, configuration information of a first resource; and
receiving, by the network device, a first request transmitted by a terminal device on the first resource,
wherein the configuration information of the first resource is carried in a master information block, and the first request is used for requesting a on-demand first system information block (SIB1).

17. An apparatus, comprising:
at least one processor; and
one or more non-transitory computer-readable storage media coupled to the at least one processor and storing programming instructions for execution by the at least one processor, wherein the programming instructions, when executed, cause the apparatus to perform operations comprising:
receiving, by a terminal device in an NES (network energy saving) cell, configuration information of a first resource; and
transmitting a first request on the first resource,
wherein the configuration information of the first resource is carried in a master information block, and the first request is used for requesting an on-demand first system information block (SIB1).

18. The apparatus according to claim 17, wherein the first request comprises a wake uplink signal (WUS), and the configuration information of the first resource is indicated by pdcch-ConfigWUS in the master information block.

19. The apparatus according to claim 17, wherein the receiving the configuration information of the first resource comprises:
detecting the configuration information of the first resource in a first search space,
wherein the first search space is a common search space or a search space specific to the terminal device.

20. The apparatus according to claim 19, wherein the on-demand SIB1 corresponds to a second search space, and the operations further comprise:
detecting, after transmitting the first request, the on-demand SIB1 in the second search space.
